(19) United States
(12) Patent Application Publication
(10) Pub. No.: US 2015/0329080 A1
(43) Pub. Date: Nov. 19, 2015

(54) CONTROL TRANSMITTER FOR A MOTOR VEHICLE AND IN PARTICULAR FOR A DEVICE FOR CLOSING A MOTOR VEHICLE, AND CONTROL SYSTEM PARTICULARLY FOR A MOTOR VEHICLE

(71) Applicant: JOHNSON CONTROLS AUTOMOTIVE ELECTRONICS SAS, Cergy Pontois Cedex (FR)

(72) Inventor: Serge BLAZEJEWSKI, Jouy Le Moutier, (FR)

(73) Assignee: JOHNSON CONTROLS AUTOMOTIVE ELECTRONICS SAS, Cergy Pontoise Cedex (FR)

(21) Appl. No.: 14/436,769

(22) PCT Filed: Oct. 15, 2013
(86) PCT No.: PCT/EP2013/071537

§ 371 Date: Apr. 17, 2015

(30) Foreign Application Priority Data
Oct. 18, 2012 (FR) FR 12/02801

(51) Int. Cl. B60R 25/20; G07C 9/00

(52) U.S. Cl. CPC B60R 25/2027; G07C 9/00007

(57) ABSTRACT

A control transmitter for a motor vehicle, and in particular for a device for closing a motor vehicle, is designed to be worn on a human body. The control transmitter includes an element for attaching or fastening the control transmitter onto the human body, and a transmitter element including an electronic circuit for transmitting an electric signal through the human body in order to actuate at least one functionality of the motor vehicle. When a portion of the human body touches a specific portion of the surface of the motor vehicle, the electric signal transmitted through the human body enables at least one functionality of the motor vehicle to be actuated.

The present invention relates to a control transmitter for a motor vehicle and, in particular, for a device for closing a motor vehicle.

Moreover, the present invention relates to a control system, particularly for a motor vehicle, comprising on the one hand a central unit and, on the other, a control transmitter.

Data transmission systems using a human body as the signal line and, more particularly, a system comprising a portable transmitter, a receiver designed to be connected to an associated piece of equipment that uses the data transmitted by the transmitter, and a piece of clothing integrally containing two electrodes to transmit the data through the human body are generally known in the art.

Moreover, remote controls are known in the art which are used for remote keyless entry functions which, by pressing keys disposed on the remote control, transmit radiofrequency signals—particularly associated with different functions or functionalities of the motor vehicle—and open or close vehicle door locks, vehicle flaps and vehicle bonnets and therefore allow or prevent access to the passenger compartment of the vehicle and to the boot. Other vehicle functions or functionalities capable of being controlled with the help of the remote control are the triggering of an alarm, termed a panic alarm, in an alarm system fitted to the vehicle, the starting of an engine in the vehicle, the opening and closing of the vehicle windows and sun roofs, as well as the automatic opening and closing of sliding doors in the vehicle. Moreover, remote controls of this kind are used for keyless access functions in a vehicle which are referred to as keyless go systems.

Moreover, there is a need to provide access to or activation of functionalities of the motor vehicle while avoiding the electromagnetic waves transmitted by an aerial, for example. Moreover, it is more convenient for a user to be able to activate a certain functionality of a motor vehicle without having a key in their hand.

This object is achieved according to the invention with a control transmitter for a motor vehicle and, in particular, for a device for closing a motor vehicle, the control transmitter being designed to be worn on a human body, comprising

an element for attaching and/or fastening the control transmitter onto the human body,

a transmitter element, the transmitter element comprising an electronic circuit for transmitting an electrical signal to pass through the human body, in order to actuate at least one functionality of the motor vehicle, the electrical signal passed through the human body allowing at least one functionality of the motor vehicle to be actuated when part of the human body touches a specific portion of the surface of the motor vehicle.

This kind of embodiment of the control transmitter allows control of at least one, but preferably a plurality of, functionalities of a vehicle without the need to resort using electromagnetic waves to transmit the signals to actuate the functionalities.

According to a preferred embodiment according to the invention, it is preferable for the control transmitter to be intended to be attached or fastened to the wrist of a user.

By means of this kind of embodiment of a remote control, it is advantageously possible according to the present invention for the control transmitter to be able to be worn by a user without too much inconvenience.

According to another preferred embodiment according to the invention, it is preferable for the control transmitter to be intended to be attached or fastened to the arm of a user.

Through this kind of embodiment of a remote control, it is advantageously possible according to the present invention for the control transmitter to be worn by a user easily and without there being any risk of losing the control transmitter.

According to another preferred embodiment according to the present invention, it is preferable for a first functionality of the motor vehicle to be actuated when part of the human body touches the specific portion of the surface of the motor vehicle and for a second functionality of the motor vehicle to be actuated when part of the human body touches another specific portion of the surface of the motor vehicle.

Through this kind of embodiment of the present invention, it is advantageously possible for several functionalities of the motor vehicle to be simply actuated by touching different parts (in other words, the specific portion for the first functionality and the other specific portion for the second functionality) of the surface of the motor vehicle.

The object of the invention is likewise achieved according to the invention with a control system, particularly for a motor vehicle, comprising on the one hand a central unit and, on the other hand, a control transmitter according to the present invention,

the control system moreover comprising a specific portion of the surface of the motor vehicle,

the specific portion of the surface of the motor vehicle being intended to be touched by part of the human body of a user.

According to another preferred embodiment of the system according to the present invention, it is preferable for a first functionality of the motor vehicle to be actuated when part of the human body touches the specific portion of the surface of the motor vehicle, a second functionality of the motor vehicle being actuated when part of the human body touches another specific portion of the surface of the motor vehicle.

According to yet another preferred embodiment of the method according to the present invention, it is preferable that when part of the human body touches the specific portion of the surface of the motor vehicle, a first set of data is passed from the transmitter element towards the central unit and a second set of data is passed from the central unit towards the transmitter element.

Other characteristics and advantages of the invention will emerge when reading the following description of a particular non-limiting embodiment of the present invention.

### BRIEF DESCRIPTION OF THE DRAWINGS

The invention will be easier to understand thanks to the following description which relates to preferred embodiments provided as non-limiting examples and explained with reference to the attached schematic drawing in which:

FIG. 1 illustrates schematically the basic principle of a control transmitter according to the present invention as a front view and

FIG. 2 illustrates schematically a control transmitter according to the invention.

### DESCRIPTION OF THE DRAWINGS

Parts that correspond to one another in all the figures are provided with the same reference numbers.

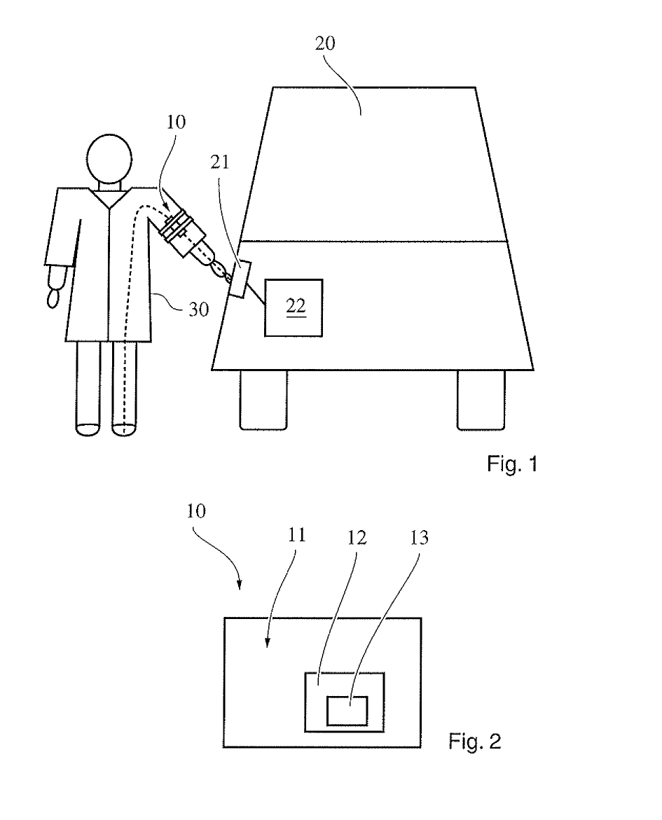

FIG. 1 illustrates schematically the situation in which an individual or a user (having a human body 30) wishes to activate a functionality of a motor vehicle 20. A control transmitter 10 is attached to the human body 30 of the individual or user.

The control transmitter 10 is particularly in electrically conductive contact (or contact having a relatively weak electrical resistance) with the human body, particularly with the skin of the user.

The motor vehicle 20 comprises at least one specific portion 21 of the surface of the motor vehicle 20. With the help of the specific portion 21 of the surface of the motor vehicle 20, a functionality of the motor vehicle 20 can be actuated by the user who is wearing the control transmitter 10. To do this, a signal transmitted by the control transmitter is passed through the human body 30 of the user to the specific portion 21 of the surface of the motor vehicle 20. The signal sent is detected by a central unit 22 which then generates a signal to activate the desired functionality.

FIG. 2 illustrates schematically a control transmitter 10 according to the invention. The control transmitter 10 comprises an element for attaching and/or fastening 11, as well as transmitter element 12. The transmitter element 12 comprises an electronic circuit 13 which serves to generate the electrical signal to be passed through the human body 30.

According to the present invention, it is possible and preferable that during prolonged contact with the specific portion 21 of the surface of the motor vehicle 20, it is possible for other doors or openable elements more generally to be opened (particularly by individuals who are not fitted with the control transmitter 10 corresponding to the motor vehicle 20).

According to the present invention, it is likewise possible and preferable that during two short contacts with the specific portion 21 of the surface of the motor vehicle 20, the door is closed again.

### LIST OF REFERENCE NUMBERS

10 control transmitter

11 element for attaching and/or fastening

12 transmitter element

13 electronic circuit

20 motor vehicle

21 specific portion of the surface of the motor vehicle

22 central unit

1. A control transmitter for a motor vehicle, the control transmitter being designed to be worn on a human body, comprising
an element for attaching and/or fastening the control transmitter onto the human body,
a transmitter element, the transmitter element comprising an electronic circuit for transmitting an electrical signal to pass through the human body, in order to actuate at least one functionality of the motor vehicle,
wherein, when part of the human body touches a specific portion of the surface of the motor vehicle, the electrical signal passed through the human body allows at least one functionality of the motor vehicle to be actuated.

2. A control transmitter according to claim 1, wherein the control transmitter is intended to be attached or fastened to the wrist of a user.

3. A control transmitter according to claim 1, wherein the control transmitter is intended to be attached or fixed to the arm of a user.

4. A control transmitter according to claim 1, wherein a first functionality of the motor vehicle is actuated when part of the human body touches the specific portion of the surface of the motor vehicle and a second functionality of the motor vehicle is actuated when part of the human body touches another specific portion of the surface of the motor vehicle.

5. A control system, particularly for a motor vehicle, comprising on the one hand a central unit and, on the other hand, a control transmitter according to claim 1, the control system moreover comprising a specific portion of the surface of the motor vehicle, the specific portion of the surface of the motor vehicle being intended to be touched by part of the human body of a user.

6. A control system according to claim 5, wherein a first functionality of the motor vehicle is actuated when part of the human body touches the specific portion of the surface of the motor vehicle, a second functionality of the motor vehicle being actuated when part of the human body touches another specific portion of the surface of the motor vehicle.

7. A control system according to claim 5, wherein when part of the human body touches the specific portion of the surface of the motor vehicle, a first set of data is passed from the transmitter element towards the central unit and a second set of data is passed from the central unit towards the transmitter element.
